(19) United States
(12) Patent Application Publication
(10) Pub. No.: US 2018/0342054 A1
(43) Pub. Date: Nov. 29, 2018

(54) SYSTEM AND METHOD FOR CONSTRUCTING AUGMENTED AND VIRTUAL REALITY INTERFACES FROM SENSOR INPUT

(71) Applicant: Bsquare Corp., Bellevue, WA (US)

(72) Inventor: David Wagstaff, Lake Forest, CA (US)

(21) Appl. No.: 15/992,001

(22) Filed: May 29, 2018

Related U.S. Application Data
(60) Provisional application No. 62/511,569, filed on May 26, 2017.

(51) Int. Cl. G06T 7/00; G06T 19/00; G06N 5/04; G06F 3/01; G06F 3/0346; G06K 9/00; G02B 27/01

(52) U.S. Cl. CPC G06T 7/0008; G06T 19/006; G06N 5/046; G02B 27/017; G06F 3/0346; G06K 9/00375; G06K 9/00201; G06F 3/013

(57) ABSTRACT

A method including receiving sensor data from a sensor array and applying it to a neural network to recognize anomalies in sensor input which represent objects and issues. The system and method structures an AR/VR interface to display the anomaly location with any associated instructions which should be used to proceed. A system for constructing augmented and virtual reality interfaces from sensor input includes a machine learning model, an interface constructor, a display, sensor data, an anomaly, a sensor array, an anomaly type and location, an instruction memory structure, a selector, a localizer, a components memory structure, an object, an alert, interface components, display locations, and instructions.

### CROSS REFERENCE TO RELATED APPLICATIONS

This application claims the benefit of U.S. provisional patent application Ser. No. 62/511,569, filed on May 26, 2017, the contents of which are incorporated herein by reference in their entirety.

### BACKGROUND

With the advent of increasing automation and computerization, many industries have seen a transition away from traditional expert-based fault diagnostics and have developed increasing reliance on diagnostic data from machine sensors. This has allowed for increases in efficiency in many cases, but has also greatly reduced the number of diagnostic and maintenance experts, while these roles are decreasing rapidly, there is greater reliance on them to fill in the gaps where sensor data fails. “Intuition” brought about by experience in the field is in rapidly decreasing supply, and new technicians being trained are often not able to access this during training or during the course of their duties.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an embodiment of a System for constructing Augmented and Virtual reality interfaces from sensor input 100.

FIG. 2 illustrates a routine 200 accordance with one embodiment.

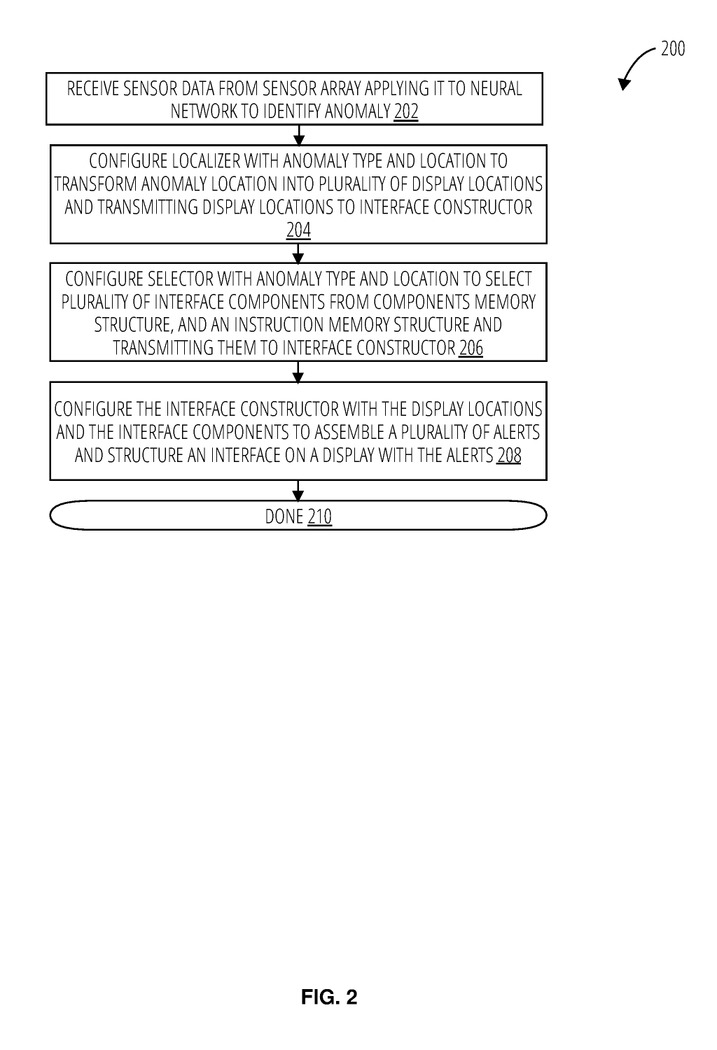

FIG. 3 illustrates an embodiment of a displayed interface of a system for constructing Augmented and Virtual Reality interfaces from sensor input 300.

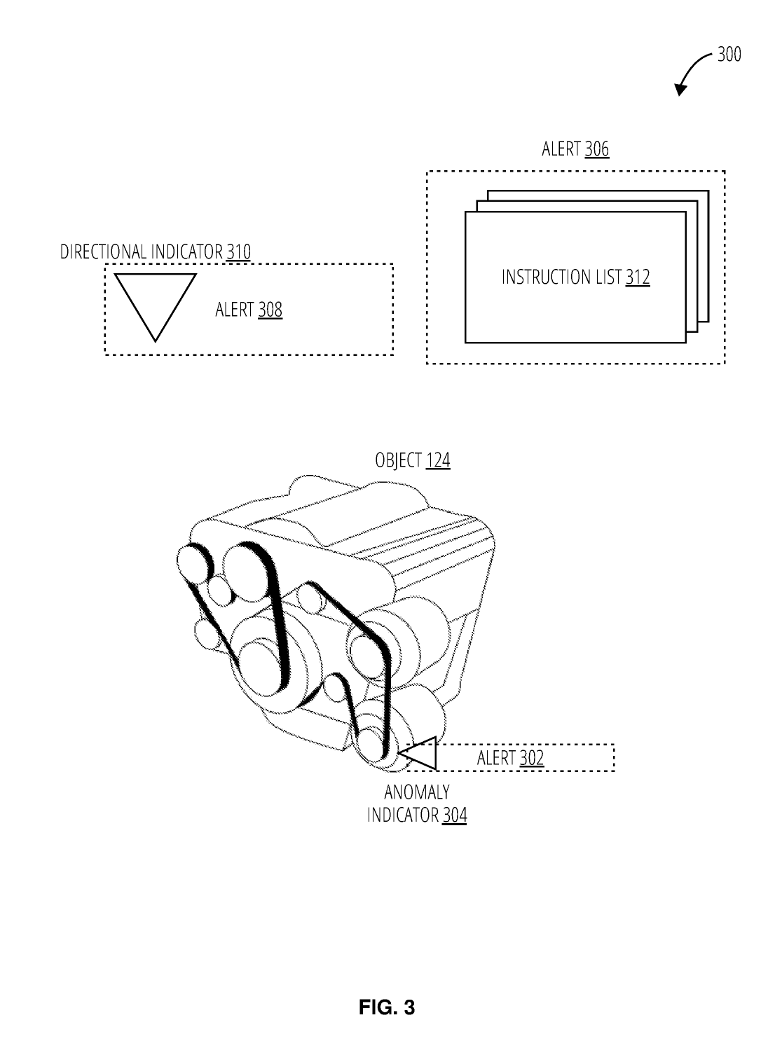

FIG. 4 illustrates a system 400 in accordance with one embodiment.

### DETAILED DESCRIPTION

The system and method herein described allow for the training of neural networks for the prediction, modeling and detection of machines. The decrease of expert personnel in a variety of fields creates a gap which cannot be filled by standard “raw” sensor data. For example, while a truck may not have any direct sensor input to indicate that there may be a suspension fault, a mechanic who has a great amount of experience with suspension components may recognize the failure of a ball joint or other component on sight, or after minimal inspection or testing. They may recognize “secondary” experiential data, such as the look of the components, the feel of the steering wheel while driving, the sound it is making and the amount of play in the joints when pressure is applied in certain directions. The expert may recognize these specific symptoms from prior experience or from making “intuitive” connections based on commonalities witnessed between different issues. Intuition and experience in a field is often the result of the human mind recognizing patterns and correlations which it has seen repeated over and over again.

The disclosed system and method embodiments utilize trained neural networks to provide suggestive data to influence a user interface for use by a technician. The technician may provide the visual, audio and tactile input, and the system may then respond by guiding the technician through a series of steps based on established maintenance protocols as well as helping the technician to walk-through the troubleshooting process and indicating where there are indications of faults.

The system and method may employ augmented reality (AR) and virtual reality (VR) to display data. Techniques well known in the art may be employed for the use of these systems. In addition the AR/VR systems may utilize a variety of sensors, these may be one-dimensional (single beam) or 2D- (sweeping) laser rangefinders, 3D High Definition LiDAR, 3D Flash LIDAR, 2D or 3D sonar sensors and one or more 2D cameras. The system may utilize mapping techniques such as SLAM (simultaneous localization and mapping) to place the user in the environment, or to augment information to and from the neural networks. SLAM utilizes sensor observations over discrete time steps to estimate an agent's location and a map of the environment. Statistical techniques used may include Kalman filters, particle filters (aka. Monte Carlo methods) and scan matching of range data.

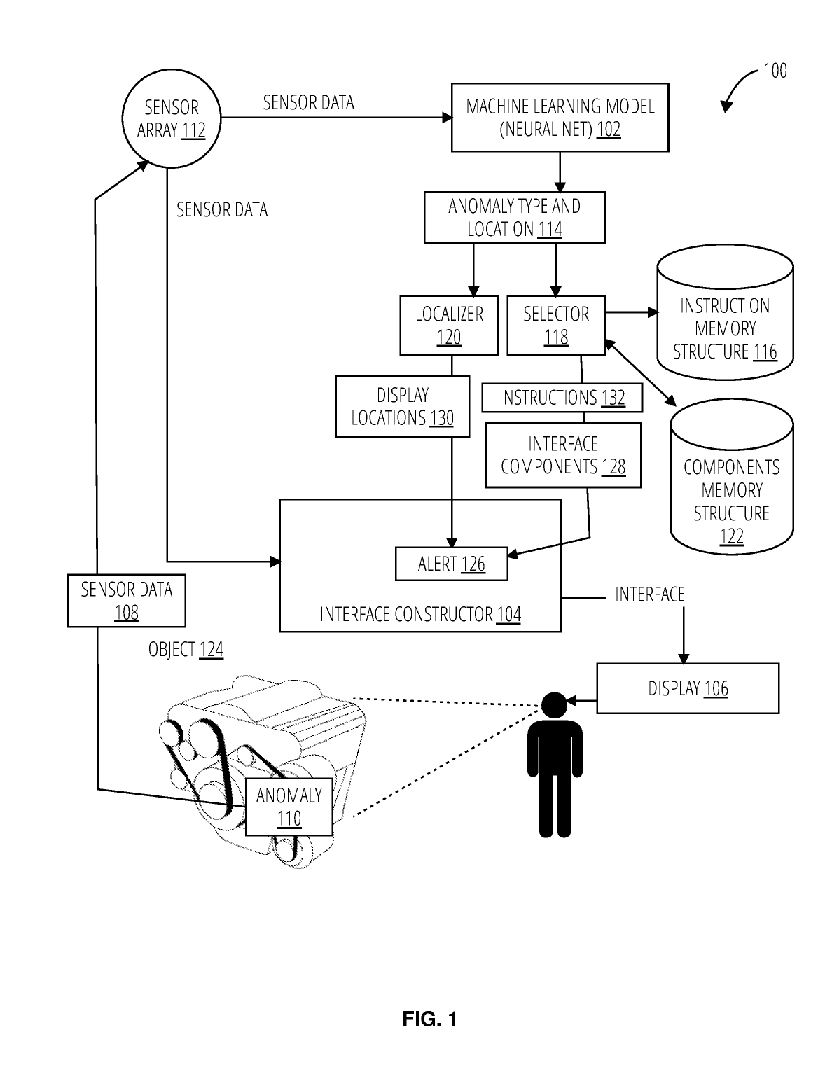

Referring to FIG. 1, the system for constructing augmented and virtual reality interfaces from sensor input 100 comprises a machine learning model (neural net) 102, an interface constructor 104, a display 106, sensor data 108, an anomaly 110, a sensor array 112, an anomaly type and location 114, an instruction memory structure 116, a selector 118, a localizer 120, a components memory structure 122, an object 124, an alert 126, interface components 128, display locations 130, and instructions 132.

A trained machine learning model (neural net) 102, receives the sensor data 108 from a sensor array 112. The sensor array 112 may comprise a wide range of input sensors, not limited to audio, visual, tactile, pressure and location sensors. The sensor array 112 reads the sensor data 108 from the object 124 and streams the sensor data 108 to the machine learning model (neural net) 102. The machine learning model (neural net) 102 detects and classifies the data as indicating the presence of an anomaly 110 on the object 124. The machine learning model (neural net) 102 transmits an anomaly type and location (on the object) 114 to a localizer 120 and a selector 118. The selector 118 selects an instruction 132 from an instruction memory structure 116 and the interface components 128 from the components memory structure 122 and transmits the interface components 128 and instructions 132 to an interface constructor 104. The localizer 120 receives the location of the anomaly 110 and correlates it with a position on the display 106 and transmits display locations 130 to the interface constructor 104. The localizer 120 may utilize a variety of tracking techniques to localize the anomaly within the environment and on the object, for example, the localizer may utilize gaze tracking, pointer tracking and hand tracking to correlate the display location with the anomaly's location in the real world. The localizer 120 may also utilize images or three-dimensional object scans correlated with the detected anomaly. The localizer 120 may receive the anomaly type and location and correlate the locations on a multi-dimensional mesh or grid with the location of the object on the display. The interface constructor 104 constructs an interface combining the location from the localizer 120 and the components and instructions from the selector 118 into an alert 126 on the display 106.

In some embodiments, the interface components 128 are at least one of controls, static icons, and combinations thereof, wherein the icons give the status of the object 124, and controls facilitate a way to remotely or locally manipulate the object 124. In embodiments, the controls may include, for example, buttons and/or sliders that allow a user to change the settings of the object remotely or display how and/or where to change the settings locally. In some embodiments, the interface components 128 comprise selector boxes that offer different options to the user for controlling various operations on the object.

In some embodiments, the alerts 126 may have multiple levels of urgency. In illustrative embodiments, a red alert may need immediate attention (e.g., critical engine failure), a yellow alert may need attention in the near future (e.g., belt is slipping on pulley causing a squealing noise), and an orange alert may need attention within a few weeks or months (e.g., oil change is due soon). In some embodiments, the alerts 126 are located in the components memory structure 122 and are selected by the selector 118 and sent to the interface constructor 104.

In some embodiments, the selection and configuration of the interface components 128 is based on the type of alert 126. As an example, if a red alert 126 is necessary, the interface components 128 selected may include a button that facilitates immediate shut-off of the object 124 or may include a sliding control that allows reduction of the speed of the object 124.

In some embodiments, the selection and configuration of the instructions 132 is based on the type of alert 126. As an example, if a red alert 126 is required, the instructions 132 may be directed to mitigating the event causing the red alert, such as how to shut down an overheating motor. Subsequent instructions may include how to repair the overheating motor.

The display 106 may comprise a computer display, an AR headset, a VR headset, and combinations thereof.

In block 202, routine 200 receives sensor data from a sensor array applying it to a neural network to identify an anomaly. In block 204, routine 200 configures a localizer with an anomaly type and location on an object to transform an anomaly location into a plurality of display locations transmitting the display locations to an interface constructor. In block 206, routine 200 configures a selector with the anomaly type and location (on an object) to select a plurality of interface components from a components memory structure an instruction memory structure transmitting them to the interface constructor. In block 208, routine 200 configures the interface constructor with the display locations and the interface components to assemble a plurality of alerts and structure an interface on a display with the alerts. In done block 210, routine 200 ends.

The method may include receiving sensor data from a sensor array and applying it to a neural network to identify an anomaly, configuring a localizer with an anomaly type and location (on an object) to transforming an anomaly location into a group of display locations and transmitting the display locations to an interface constructor. A selector may be configured with the anomaly type and location (on an object) to select a group of interface components from a components memory structure and an instruction memory structure, transmitting them to the interface constructor, and/or configuring the interface constructor with the display locations and the interface components to assemble a group of alerts and structure an interface on a display with the alerts.

The alerts may include at least one of an instruction list, a directional indicator, an anomaly indicator, and combinations thereof.

In an embodiment, the interface constructor utilizes the anomaly location to structure the display to prevent the overlap of the anomaly and the alerts.

The system for constructing augmented and virtual reality interfaces from sensor input 300 comprises an object 124, an alert 302, an anomaly indicator 304, an alert 306, an alert 308, a directional indicator 310, and an instruction list 312.

The object 124 is displayed on the display 106. The alert 126 may further comprise the alert 308, the alert 306, and the alert 302. The alert 308 may further comprise the directional indicator 310. The alert 306 may further comprise the instruction list 312, the alert 302 may further comprise the anomaly indicator 304.

The user interface may be constructed by the interface constructor 104 positioning the anomaly indicator 304 at the location of the anomaly 110 indicated by the localizer 120. The directional indicator 310 may be positioned so as to intuitively indicate the direction the user should look in order to best proceed with the instructions or other alerts. The instruction list 314 may indicate the appropriate next steps to be taken by the user.

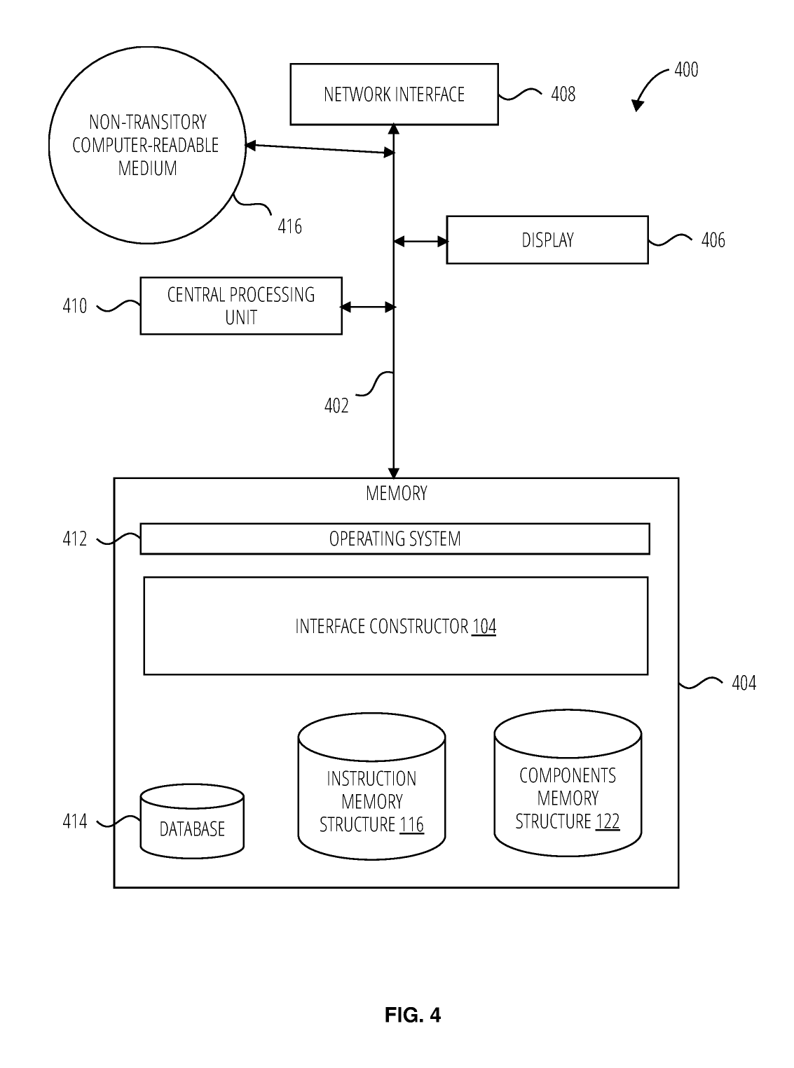

FIG. 4 illustrates several components of an exemplary system 400 in accordance with one embodiment. In various embodiments, system 400 may include a desktop PC, server, workstation, mobile phone, laptop, tablet, set-top box, appliance, or other computing device that is capable of performing operations such as those described herein. In some embodiments, system 400 may include many more components than those shown in FIG. 4. However, it is not necessary that all of these generally conventional components be shown in order to disclose an illustrative embodiment. Collectively, the various tangible components or a subset of the tangible components may be referred to herein as “logic” configured or adapted in a particular way, for example as logic configured or adapted with particular software or firmware.

In various embodiments, system 400 may comprise one or more physical and/or logical devices that collectively provide the functionalities described herein. In some embodiments, system 400 may comprise one or more replicated and/or distributed physical or logical devices.

In some embodiments, system 400 may comprise one or more computing resources provisioned from a “cloud computing” provider, for example, Amazon Elastic Compute Cloud (“Amazon EC2”), provided by Amazon.com, Inc. of Seattle, Wash.; Sun Cloud Compute Utility, provided by Sun Microsystems, Inc. of Santa Clara, Calif.; Windows Azure, provided by Microsoft Corporation of Redmond, Wash., and the like.

System 400 includes a bus 402 interconnecting several components including a network interface 408, a display 406, a central processing unit 410, and a memory 404.

Memory 404 generally comprises a random access memory (“RAM”) and permanent non-transitory mass storage device, such as a hard disk drive or solid-state drive. Memory 404 stores an operating system 412.

These and other software components may be loaded into memory 404 of system 400 using a drive mechanism (not shown) associated with a non-transitory computer-readable medium 416, such as a floppy disc, tape, DVD/CD-ROM drive, memory card, or the like.

Memory 404 also includes database 414. In some embodiments, system 400 may communicate with database 414 via network interface 408, a storage area network (“SAN”), a high-speed serial bus, and/or via the other suitable communication technology.

In some embodiments, database 414 may comprise one or more storage resources provisioned from a “cloud storage” provider, for example, Amazon Simple Storage Service (“Amazon S3”), provided by Amazon.com, Inc. of Seattle, Wash., Google Cloud Storage, provided by Google, Inc. of Mountain View, Calif., and the like.

“Anomaly” herein refers to a deviation from an expected value, range, arrangement, form, type, or outcome.

“Circuitry” herein refers to electrical circuitry having at least one discrete electrical circuit, electrical circuitry having at least one integrated circuit, electrical circuitry having at least one application specific integrated circuit, circuitry forming a general purpose computing device configured by a computer program (e.g., a general purpose computer configured by a computer program which at least partially carries out processes or devices described herein, or a microprocessor configured by a computer program which at least partially carries out processes or devices described herein), circuitry forming a memory device (e.g., forms of random access memory), or circuitry forming a communications device (e.g., a modem, communications switch, or optical-electrical equipment).

“Firmware” herein refers to software logic embodied as processor-executable instructions stored in read-only memories or media.

“Hardware” herein refers to logic embodied as analog or digital circuitry.

“Logic” herein refers to machine memory circuits, non-transitory machine readable media, and/or circuitry which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter).

“Selector” herein refers to logic implemented to select at least one item from a plurality of items, for example, a multiplexer, or switch.

“Software” herein refers to logic implemented as processor-executable instructions in a machine memory (e.g. read/write volatile or nonvolatile memory or media).

“Trained machine learning model” herein refers to a neural network that has learned tasks by considering examples and evolving a set of relevant characteristics from the learning materials that the network possesses. In an embodiment, the trained machine learning model is Google's GoogLeNet also known as Inception-v1, a general purpose image recognition neural network. One of skill in the art will realize that this model may be modified for particular tasks, e.g., replacing the softmax classification layer in Inception-v1 and returning the weights of the last dozen layers to refine them for the specific image recognition portion of that task.

Herein, references to “one embodiment” or “an embodiment” do not necessarily refer to the same embodiment, although they may. Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively, unless expressly limited to a single one or multiple ones. Additionally, the words “herein,” “above,” “below” and words of similar import, when used in this application, refer to this application as a whole and not to any particular portions of this application. When the claims use the word “or” in reference to a list of two or more items, that word covers all of the following interpretations of the word: any of the items in the list, all of the items in the list and any combination of the items in the list, unless expressly limited to one or the other.

Any terms not expressly defined herein have their conventional meaning as commonly understood by those having skill in the relevant art(s).Various logic functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on.

What is claimed is:

1. A method comprising:
receiving sensor readings from a sensor array directed to an object and applying the sensor readings to a neural network to identify an anomaly associated with the object;
configuring a localizer with an anomaly type and the location of the anomaly on the object to generate an anomaly location;
transforming the anomaly location into a plurality of display locations and transmitting the display locations to an interface constructor, wherein the localizer correlates the display locations with the anomaly location in the real world;
operating a selector with the anomaly type and the anomaly location to select a plurality of interface components from a components memory structure and instructions from an instruction memory structure, and transmitting the interface components and instructions to the interface constructor; and
configuring the interface constructor with the display locations and the interface components to assemble a plurality of alerts and structure an interface on a display with the alerts.

2. The method of claim 1, wherein the alerts comprise at least one of an instruction list, a directional indicator, an anomaly indicator, and combinations thereof.

3. The method of claim 1, wherein the interface constructor utilizes the anomaly location to structure the display to prevent the overlap of the anomaly and the alerts.

4. The method of claim 1, wherein the localizer uses tracking techniques to localize the anomaly within a physical environment and on the object.

5. The method of claim 4, wherein the tracking techniques include at least one of gaze tracking, pointer tracking, hand tracking, and combinations thereof.

6. The method of claim 1, wherein the localizer utilizes at least one of images, three-dimensional object scans, and combinations thereof, correlated with the detected anomaly.

7. The method of claim 1, wherein the localizer receives the anomaly type and the location of the anomaly on the object and correlates the location of the anomaly on the object on a multi-dimensional mesh or grid with the location of the object on the display.

8. The method of claim 1, wherein the display comprises at least one of a computer display, an augmented reality headset, a virtual reality headset, and combinations thereof.

9. The method of claim 1, wherein the interface components comprise alerts directed to an object, and the selection and configuration of the interface components is based on the type of alert.

10. The method of claim 1, wherein the interface components comprise controls operable to alter the operation of the object for which the alert applies.

11. A computing apparatus, the computing apparatus comprising:
a processor; and
a memory storing instructions that, when executed by the processor, configure the apparatus to:
receive sensor readings from a sensor array directed to an object and applying the sensor readings to a neural network to identify an anomaly associated with the object;
configure a localizer with an anomaly type and the location of the anomaly on the object to generate an anomaly location and transform the anomaly location into a plurality of display locations and transmitting the display locations to an interface constructor;
a selector with the anomaly type and the anomaly location to select a plurality of interface components from a components memory structure and instructions from an instruction memory structure, and transmitting the interface components and instructions to the interface constructor; and
configure the interface constructor with the display locations and the interface components to assemble a plurality of alerts and construct an interface on a display.

12. The computing apparatus of claim 11 wherein the alerts comprise at least one of a list of instructions, a directional indicator, an anomaly indicator, and combinations thereof.

13. The computing apparatus of claim 11 wherein the interface constructor utilizes the anomaly location to structure the display to prevent the overlap of the anomaly and the alerts.

14. A method comprising:
receiving sensor readings from a sensor array directed to an object and applying the sensor readings to a neural network to identify an anomaly associated with the object;
configuring a localizer with an anomaly type and the location of the anomaly on the object to generate an anomaly location;
transforming the anomaly location into a plurality of display locations and transmitting the display locations to an interface constructor, wherein the localizer correlates the display locations with the anomaly location in the real world;
operating a selector with the anomaly type and the anomaly location to select a plurality of interface components from a components memory structure and instructions from an instruction memory structure, and transmitting the interface components and instructions to the interface constructor, wherein the interface components comprise alerts directed to an object and the selection and configuration of the interface components is based on the type of alert, and the interface components comprise controls operable to alter the operation of the object for which the alert applies; and
configuring the interface constructor with the display locations and the interface components to assemble a plurality of alerts and structure an interface on a display with the alerts, wherein the alerts comprise at least one of a list of instructions, a directional indicator, an anomaly indicator, and combinations thereof, wherein the interface constructor utilizes the anomaly location to structure the display to prevent the overlap of the anomaly and the alerts, wherein the display comprises at least one of an augmented reality headset, a virtual reality headset, and combinations thereof.
